(19) United States
(12) Patent Application Publication
(10) Pub. No.: US 2019/0255901 A1
(43) Pub. Date: Aug. 22, 2019

(54) Motor Vehicle Comprising a Chassis and a Passenger Cell

(71) Applicant: Bayerische Motoren Werke Aktiengesellschaft, Muenchen (DE)

(72) Inventors: Claus BRANDT, Muenchen (DE); Hans-Peter ECK, Riemerling (DE); Juergen GREIL, Woerthsee (DE); Lars LEICHTL, Fichtelberg (DE); Albert STRASSENBERGER, Pilsting (DE)

(21) Appl. No.: 16/405,252

(22) Filed: May 7, 2019

Related U.S. Application Data
(63) Continuation of application No. PCT/EP2017/078645, filed on Nov. 8, 2017.

(30) Foreign Application Priority Data
Nov. 8, 2016 (DE) 10 2016 221 913.8

(51) Int. Cl. B60G 13/18; B62D 24/02

(52) U.S. Cl. CPC B60G 13/18; B62D 24/02; B60G 2204/128; B60G 2204/16; B60G 2204/15

(57) ABSTRACT

A motor vehicle has a chassis and a passenger cell which is mounted on the chassis by way of vibration-damping connection elements. The chassis forms an undercarriage with at least two front wheels mutually spaced in the transverse direction of the vehicle and at least two rear wheels mutually spaced in the transverse direction of the vehicle, and with at least one drive device. The chassis is provided with front and rear energy-absorbing deformation elements of a front and rear bumper structure, respectively.

### CROSS REFERENCE TO RELATED APPLICATIONS

This application is a continuation of PCT International Application No. PCT/EP2017/078645, filed Nov. 8, 2017, which claims priority under 35 U.S.C. § 119 from German Patent Application No. 10 2016 221 913.8, filed Nov. 8, 2016, the entire disclosures of which are herein expressly incorporated by reference.

### BACKGROUND AND SUMMARY OF THE INVENTION

The invention relates to a motor vehicle having a chassis and a passenger cell which is mounted on the chassis via vibration-damping connection elements.

In the current prior art, the drive train, running-gear unit and body regions in motor vehicles are usually separated both functionally and geometrically. This ensures that vibrations which act on the motor vehicle from the drive train or from the ground via the running-gear unit do not act directly on the passenger cell. This strict separation gives rise to costs, additional joining points, increased weight and an increased complexity of the overall structure of the motor vehicle.

There have already been proposed motor vehicle designs having drive and running-gear components which are rigidly integrated into a substructure of the motor vehicle. In this case, however, the problem arises that, with such a design, vibrations which are normally absorbed via acoustic bearings are transmitted to adjacent components and thus lead to considerable and unacceptable losses in comfort.

EP 1 040 041 B1 shows and describes a vehicle having a frame which receives a drive unit and a running-gear unit of the vehicle, wherein a vehicle body for receiving vehicle occupants is connected to the vehicle frame via coupling elements. The coupling elements are arranged at vibration nodes of the natural bending form of the frame. Examples of coupling elements which are used are rubber-metal bearings which have an elastomer material.

EP 2 417 005 B1 discloses a motor vehicle having a chassis frame and a vehicle body, wherein the chassis frame receives the running-gear unit with a front axle and a rear axle. Provided in front of and behind the respective axle are connection elements which connect the vehicle body to the chassis frame. These connection elements are configured in such a way that the transverse rigidity of the connection elements can be changed. Such a change in the transverse rigidity of the connection elements during travel is intended to achieve a particularly high ride comfort and acoustic comfort.

DE 696 02 973 T2 shows and describes a motor vehicle having a carrier frame which has a unit of cells which extend in the longitudinal direction and which are used as containers for vehicle fluids, for example for fuel, oil or cooling liquid. The drive unit, which has an internal combustion engine, is directly connected to the vehicle frame, wherein the engine block is attached via a respective seal to the cells in the carrier frame, with the result that a fluid exchange can occur between the interior of the cells in the carrier frame and the engine block.

It is an object of the present invention to provide a motor vehicle having a chassis and a passenger cell whose weight is reduced and which can be produced with reduced effort.

According to an aspect of the invention, a motor vehicle has a chassis and a passenger cell, wherein the passenger cell is mounted on the chassis by way of vibration-damping connection elements. The chassis has a running-gear unit with at least two front wheels spaced apart from one another in the vehicle transverse direction and at least two rear wheels spaced apart from one another in the vehicle transverse direction, and at least one drive device, wherein the chassis is provided with front and rear energy-absorbing deformation elements of a front and rear bumper structure, respectively.

The chassis comprising the running-gear unit, the drive device and the energy-absorbing deformation elements forms an integrated substructure of the motor vehicle that has the required components for locomotion and crash safety. The passenger cell is acoustically decoupled therefrom by way of the vibration-damping connection elements. This acoustic decoupling of the passenger cell makes it possible to dispense with vibration-damping bearings within the substructure. The result is that, on the one hand, weight and material costs are saved, and on the other hand, a rigid attachment of components to the substructure is enabled. These rigidly attached components can perform load-bearing functions of the substructure. The provision of the deformation elements in the chassis means that the crash structures are virtually completely shifted into the chassis, with the result that the vehicle cell can be of substantially lighter design, which in turn means that the vibration-damping connection elements have to support a smaller mass and thus themselves have a smaller weight and can be of small design.

With preference, the chassis is provided with lower engagement elements, preferably pointing toward the passenger cell, and the passenger cell is provided with upper engagement elements, preferably pointing toward the chassis. Here, the lower engagement elements and the upper engagement elements are arranged in such a way that, in the event of a collision of the vehicle, lower engagement elements come into positive connection with upper engagement elements and secure the passenger cell in at least one direction on the chassis. This development of the motor vehicle according to the invention ensures, in the event of a collision, a rigid mechanical coupling between chassis and passenger cell at least in the collision direction, with the result that the reduction in kinetic energy that occurs in the deformation elements of the chassis also has a direct effect on the passenger cell. In the normal case, the upper and the lower engagement elements are disengaged and are not in contact with one another, specifically even not during relatively strong driving state-related acceleration or braking operations. It is only in the event of a collision or of a (complete or partial) rollover of the vehicle, that is to say only when the passenger cell is displaced relative to the chassis over and beyond a predetermined distance, which is, for example, in the region of 0.5 to 2.5 cm, that the upper and lower engagement elements come into contact with one another. They then enter into a mechanical positive connection and secure the passenger cell on the chassis in such a way that the passenger cell is supported, in the direction of the acceleration currently acting on it relative to the chassis, on the chassis.

It is also advantageous if the vibration-damping elements are designed to damp infrasonic vibrations and/or structure-borne vibrations and/or vibrations in the range of the sound spectrum audible to humans. These acoustic damping properties allow a situation in which virtually no or only minor acoustic damping measures have to be taken in the passenger cell, which contributes to a cost and weight reduction of the motor vehicle.

It is particularly advantageous if the at least one drive device is rigidly connected to the chassis. In this way, the drive device can perform a load-bearing function in the chassis, with the result that further weight can be saved.

The at least one drive device preferably has an electric motor as a drive element. The housing of the electric motor can be incorporated as a load-bearing component into the structure of the chassis.

It is advantageous here if electrical power sources for supplying power to the at least one drive device are provided which have a housing which is rigidly connected to the chassis. Thus, the housing of the power sources, for example of accumulators or fuel cells, can also perform a load-bearing function in the chassis.

The electrical power sources advantageously have fuel cells, and fuel reservoirs for the fuel cells are provided which have a housing which is rigidly connected to the chassis. In this way, a fuel supply tank, for example a hydrogen supply tank, for the fuel cells can also be integrated as a load-bearing part into the structure of the chassis.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a partially sectioned side view of a motor vehicle according to an embodiment of the invention.

FIG. 2 is a plan view of the chassis of the motor vehicle shown in FIG. 1.

FIG. 3 is a partially sectioned and enlarged view of a mechanical engagement structure between chassis and passenger cell in the direction of the arrow III in FIG. 2.

### DETAILED DESCRIPTION OF THE DRAWINGS

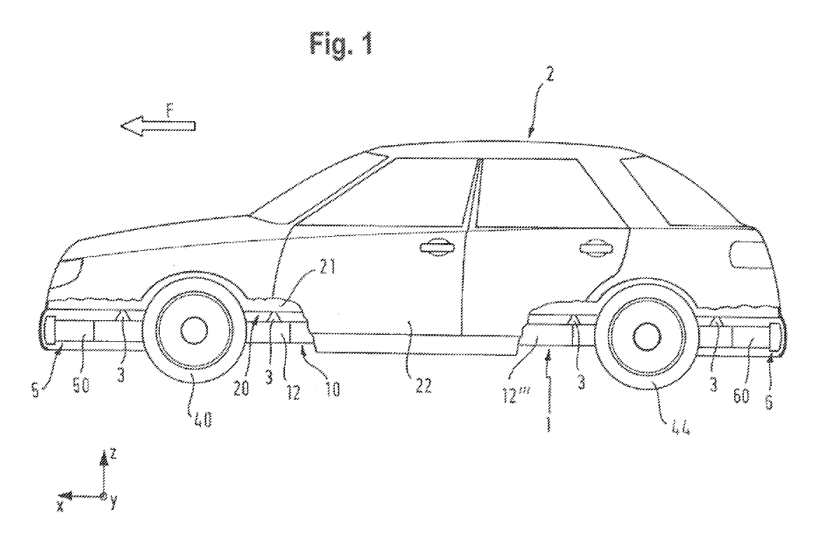

FIG. 1 shows a motor vehicle designed according to the present invention, comprising a chassis 1 and a passenger cell 2. The passenger cell 2 has a cell structure 20 and an outer skin 22. The cell structure 20 of the passenger cell 2 is mounted on the chassis 1 by use of vibration-damping connection elements 3, wherein the vibration-damping connection elements 3 are only schematically illustrated in FIG. 1. Apart from the vibration-damping connection elements 3, there are no rigid mechanical connections between the chassis 1 and the passenger cell 2 in the normal operating state via which structure-borne sound or other vibrations could be transmitted from the chassis 1 to the passenger cell 2.

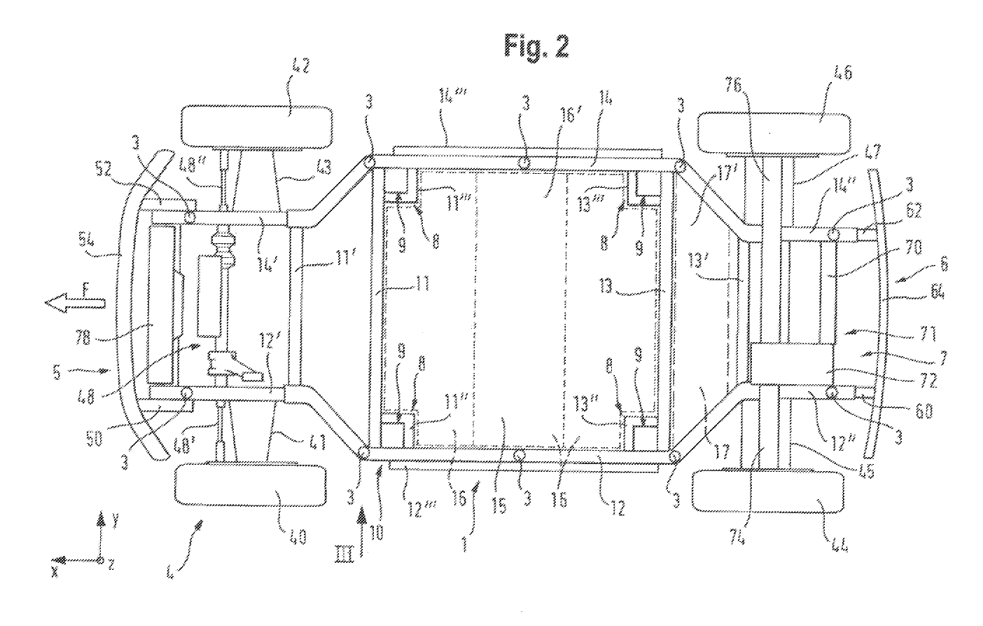

The chassis 1 illustrated in FIG. 2 forms a running-gear unit 4 with two front wheels 40, 42 which are spaced apart from one another in the vehicle transverse direction y and which are each mounted on the chassis 1 by means of a wheel suspension 41, 43. Furthermore, the running-gear unit 4 has two rear wheels 44, 46 which are spaced apart from one another in the vehicle transverse direction y and which are likewise mounted on the chassis 1 by means of a respectively assigned wheel suspension 45, 47. The running-gear unit 4 has, furthermore, a steering system 48 which, in a conventional manner, acts on the respective front wheel 40, 42 via track rods 48′, 48″.

In the example shown, the chassis 1 has a vehicle frame 10 with a left frame longitudinal member 12 and a right frame longitudinal member 14 which are connected to one another via a front frame crossmember 11, a front frame head crossmember 11′, a rear frame crossmember 13 and a rear frame head crossmember 13′. In the region of the front of the vehicle, the respective frame longitudinal member 12, 14 is provided with a front frame longitudinal member portion 12′, 14′ which projects forward beyond the front wheels in the direction of travel F and on which the front wheel suspension 41, 43 is respectively articulated. The front frame longitudinal member portions 12′, 14′ form, together with the front frame head crossmember 11′, a front frame head. In a similar manner, the frame longitudinal members 12, 14 are respectively provided, in the rear region of the chassis 1, with a rear frame longitudinal member portion 12″, 14″ which projects rearwardly beyond the rear wheels 44, 46, that is to say counter to the direction of travel F. The two rear frame longitudinal member portions 12″ and 14″ form, together with the rear frame head crossmember 13′, a rear frame head.

As can be seen in FIG. 2, energy-absorbing deformation elements 50, 52 of a front bumper structure 5 are mounted on the free end of the respective front frame longitudinal member portion 12′, 14′, and a bumper crossmember 54 is for its part mounted on the deformation elements 50, 52. In a similar manner, a rear bumper structure 6 is provided which has energy-absorbing deformation elements 60, 62 which are mounted on the respective rear frame longitudinal member portion 12″, 14″ and which are connected to a rear bumper crossmember 64.

Lateral crash reinforcements 12″, 14″, which likewise have energy-absorbing properties, are mounted in the region between the front wheels 40, 42 and the rear wheels 44, 46 on the outside of the frame longitudinal members 12, 14.

It can furthermore be seen in FIG. 2 that, in the region of the rear frame head, there is provided a drive device 7 in which a drive machine 70 and a transmission mechanism 72 form an engine/motor-transmission unit 71. The transmission mechanism 72 acts on two drive shafts 74, 76 which each mechanically apply rotating drive energy to one of the rear wheels 44, 46.

The drive machine 70 can be formed by an electric motor or an internal combustion engine. If the drive machine 70 is formed by an electric motor, the space between the central portions of the two frame longitudinal members 12, 14, that is to say between the frame head crossmembers 11′ and 13′, can be designed as a closed frame box with an underfloor 15. Electrical power sources 16, for example electrical energy accumulators and/or fuel cells, can be provided on the underfloor 15, that is to say for example within the frame box. If the drive machine 70 has an internal combustion engine or the electrical power source 16 has a fuel cell, a fuel reservoir 17 can be provided between the frame longitudinal members 12, 14. As an alternative to being accommodated in a closed frame box, the electrical power sources 16 and/or the fuel reservoir 17 can be accommodated in a respective housing 16′, 17′ which is arranged between the two frame longitudinal members 12, 14 and rigidly connected thereto, with the result that the respective housing 16′, 17′ forms a load-bearing chassis element. In order to cool the energy accumulators or the fuel cells or, if the drive machine 70 is an internal combustion engine, in order to cool the internal combustion engine, a radiator arrangement 78 is provided between the front ends of the front frame longitudinal member portions 12′, 14′, which radiator arrangement 78 can likewise be rigidly connected to the respective front frame longitudinal member portion 12′, 14′ and thereby contributes to the rigidity of the frame 10.

Both the drive machine 70 and the transmission mechanism 72 are provided with a rigid housing and are rigidly connected to one another and to the rear left frame member portion 12″ and to the rear right frame member portion 14″, with the result that the engine/motor-transmission unit 71 performs the function of a frame head crossmember. In this case, it is also possible, for example, for the rear frame head crossmember 13 to be dispensed with.

This direct rigid attachment of the engine/motor-transmission unit 71 to the frame 10 of the chassis 1 and the direct articulation of the wheel suspensions 41, 43, 45, 47 on the frame 10 of the chassis 1 have the effect that vibrations of the drive and of the running-gear unit are channeled directly into the chassis 1. To ensure that these vibrations are not transmitted into the passenger cell 2, the passenger cell 2 is, as has already been stated, fastened to the chassis 1 by way of the vibration-damping connection elements 3. Although ten vibration-damping connection elements 3 are schematically illustrated by way of example in FIGS. 1 and 2, more or fewer vibration-damping connection elements 3 can be provided for fastening the passenger cell 2 on the chassis 1, it also being possible for said connection elements to have different designs.

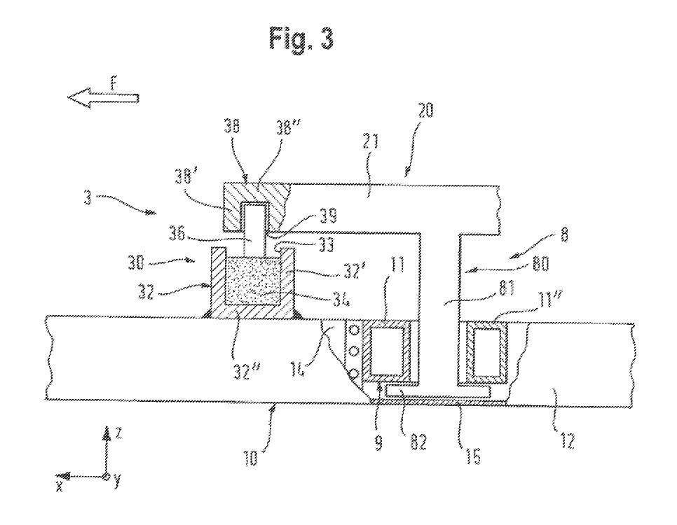

The structure and the mode of operation of the vibration-damping connection elements 3 and the attachment of the passenger cell 2 to the chassis 1 are described in detail below with reference to FIG. 3. For simplification, only one of the connection elements 3 is described here. Since, in this example, all the connection elements 3 are preferably identically designed, there is no need here for a description of the further connection elements 3. The statements below therefore apply, unless stated otherwise, to all connection elements 3.

The connection elements 3 comprise supports 30 for the passenger cell 2 on the chassis 1. These supports 30 are provided on top of or on the chassis structure, for example on top of or on the vehicle frame 10, and have a lower bearing receptacle 32 which is fixedly connected to the frame longitudinal member 12 in the example shown and which has a cup-like design with an upwardly open, preferably cylindrical, receiving opening 33. The lower bearing receptacle 32 is welded, for example, on or on top of the frame longitudinal member 12. A rubber-metal element 34 having a supporting bolt 36 projecting upwardly out of the receiving opening is inserted into the receiving opening 33. Here, the supporting bolt 36 is connected only to the rubber-metal element 34 and is held by the latter; it is not in contact—not even under the weight of the passenger cell—with the wall 32′ or the base 32″ of the lower bearing receptacle 32.

The cell structure 20 of the passenger cell 2 has lower structural longitudinal members and structural crossmembers, of which only a left structural longitudinal member 21 is shown in FIGS. 1 and 3. On the structural longitudinal members of the cell structure 20, as is shown by way of example on the structural longitudinal member 21 in FIG. 3, there is provided a cup-like upper bearing receptacle 38 which is either integrated into the structural longitudinal member 21 or is mounted thereon. The upper bearing receptacle 38 is provided with a downwardly open receiving opening 39 into which the supporting bolt 36 engages when the passenger cell 2 is connected to the chassis 1, wherein the supporting bolt 36 is surrounded by the wall 38′ of the bearing receptacle 38 and wherein the base 38″ of the bearing receptacle 38 is supported on the supporting bolt 36.

Between the chassis 1 and the passenger cell 2 there is furthermore provided at least one mechanical engagement device 8 which, in the event of a collision of the vehicle with an obstacle or with another vehicle or, in the event of a rollover of the vehicle, produces a positive connection of respective structural parts of the chassis 1 and of the passenger cell 2 after overcoming a slight relative displacement between passenger cell 2 and chassis 1. This relative displacement, and hence also the clearances which surround the components of the engagement device that are still to be described below, are greater than the vibration amplitudes of the respective rubber-metal elements 34 of the connection elements 3 in the relevant direction. In FIG. 2, the chassis-side lower parts forming lower engagement elements 9 are represented by way of example by four engagement devices 8; it is of course also possible, however, for more or fewer engagement devices 8 to be provided.

The structure and the mode of operation of the engagement devices are described with reference to FIG. 3 on the basis of a front engagement device 8. The statements below therefore apply, unless otherwise stated, to all engagement devices, wherein the rear engagement devices can be arranged in mirror-inverted fashion to the illustration of FIG. 3.

The cell structure 20 of the passenger cell 2 is provided with upper engagement elements 80 which point toward the chassis 1 and which, in the example shown, have an engagement bolt 81 which extends downward toward the chassis 1 from the lower structural longitudinal member 21 of the cell structure 20 of the passenger cell 2. The engagement bolt 81 can be welded on the structural longitudinal member 21, be formed in one piece therewith or be removably connected, for example screwed, thereto. The engagement bolt 81 is provided at its lower free end with at least one hook attachment 82 which extends in the vehicle longitudinal direction. This hook attachment 82 can extend forward and/or rearward in the vehicle longitudinal direction x. Alternatively or in addition, a further hook attachment (not shown) can also be provided on the free end of the engagement bolt 81, which hook attachment extends on one side or both sides in the vehicle transverse direction y.

If the passenger cell 2 is placed on the chassis 1, the engagement bolt 81 is positioned behind the front frame crossmember 11 (or, in the case of a rear engagement device, in front of the rear frame crossmember 13). Here, the hook attachment 82 engages under the frame crossmember without, however, coming into contact therewith in the normal state. In the normal state, that is to say if no collision occurs, the engagement bolt 81 is also in no contact with any part of the chassis 1. Even under strong positive or negative driving state-related acceleration, the engagement bolt 81 and its hook attachment 82 do not come into contact with the chassis 1. It is only in the event of a collision in which, for example, a force is applied to the vehicle counter to the direction of travel that the front frame crossmember 11 forms a stop for the engagement bolt 81 and hence a lower engagement element 9. A positive engagement occurs here between passenger cell 2 and chassis 1. In an analogous manner, the rear frame crossmember 13 forms a stop for the corresponding engagement bolt if, during a collision from behind (for example a rear-impact crash), the vehicle is subjected to a collision force in the direction of travel. The engagement device acts in a corresponding manner even under collision forces acting on the vehicle from the side.

In the event of a rollover of the vehicle, the hook attachments 82 of the engagement devices 8 come into contact with the underside of the frame member 11 or 13 and arrest the passenger cell 2 in the z direction on the chassis 1.

Even though the above-described embodiment already suffices to ensure that, in the event of a collision, the collision-related forces do not have to be supported via the connection elements, an additional frame crossmember 11″, 11″ (or 13″, 13″) or a corresponding frame crossmember portion can additionally be provided on the frame 10 on the side of the hook attachment 82 that faces away from the front frame crossmember 11 (or from the rear frame crossmember 13), said additional frame crossmember or said frame crossmember portion delimiting the engagement bolt 81 on the opposite side and, in the event of a corresponding collision, likewise forming a stop for the engagement bolt 81.

The idea of the invention essentially comprises providing a highly integrative, self-supporting substructure (chassis) for a motor vehicle on which the passenger cell is mounted in a vibration-decoupled manner and which nevertheless secures the chassis and passenger cell to one another in the event of a collision or a rollover, in order to allow the collision energy-absorbing structures provided in the chassis also to become effective for the passenger cell. In particular, the invention provides acoustic decoupling of the passenger cell from the substructure (chassis).

In the highly integrative, self-supporting substructure, it is possible for drive units, axles, high-voltage accumulators in electric vehicles, optionally hydrogen drive components, and further components to be connected to one another, for example rigidly, without any acoustic decoupling. Consequently, these structures jointly perform functional static functions such as supporting operating loads, crash loads or driving-dynamics loads. It is also possible, for example, for wheel suspensions to be articulated on the chassis without acoustic damping means. By virtue of the chassis taking up the main loads, the passenger cell can be designed to be considerably lighter. Thus, for example, wall thicknesses can be reduced or sound insulation can be dispensed with.

As a result of the acoustic decoupling via an elastic bearing of the passenger cell on the substructure, that is to say on the chassis, vibrations are absorbed via the vibration-damping connection elements forming an interposed spring damper system, with the result that no user-relevant limitations in terms of acoustics arise and without the driving dynamics being noticeably limited.

This design with the highly integrated substructure (chassis) associated with the acoustic decoupling by the elastic bearing of the passenger cell leads to a considerable weight reduction associated with a considerable cost reduction by dispensing with components or by reducing the number of components in the overall system. Examples of this are the possible dispensing with a rear axle carrier, the possible dispensing with elastic bearings of the axles or reduced wall thicknesses of the passenger cell.

This results in considerable advantages, such as, for example, a significant improvement in the rolling acoustics. The add-on parts, such as the electric machine, the transmission, the axles or the high-voltage accumulators, are designed as load-bearing and stiffening components and thereby allow the configuration of a new topology for the overall vehicle. Decoupled subcomponents and subsystems present in a conventional design, such as, for example, the rear axle carriers or the engine/motor mounts, can be dispensed with. This results in weight and cost advantages, even in the assembly process.

This solution according to the invention is particularly advantageous for electric vehicles, but can also be applied for vehicles having internal combustion engines and other drives.

The invention is not limited to the above exemplary embodiment, which serves merely for the general explanation of the essential concept of the invention. Rather, within the scope of protection, the device according to the invention can also adopt other design forms than those described above. In this connection, the device can have features in particular which constitute a combination of the respective individual features of the claims.

Reference signs in the claims, the description and the drawings merely serve for the better understanding of the invention and are not intended to limit the scope of protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle, comprising:
a chassis;
vibration-damping connection elements; and
a passenger cell which is mounted on the chassis by way of the vibration-damping connection elements, wherein
the chassis forms a running-gear unit with at least two front wheels spaced apart from one another in a vehicle transverse direction and at least two rear wheels spaced apart from one another in the vehicle transverse direction, and has at least one drive device, and
the chassis is provided with front and rear energy-absorbing deformation elements of a front and rear bumper structure, respectively.

2. The motor vehicle as claimed in claim 1, wherein
the chassis is provided with lower engagement elements,
the passenger cell is provided with upper engagement elements, and
the lower engagement elements and the upper engagement elements are arranged such that, in an event of a collision and/or a rollover of the vehicle, the lower engagement elements come into positive connection with the upper engagement elements and secure the passenger cell in at least one direction on the chassis.

3. The motor vehicle as claimed in claim 2, wherein
the vibration-damping elements are configured to damp infrasonic vibrations and/or structure-borne vibrations and/or vibrations in a spectrum range audible to humans.

4. The motor vehicle as claimed in claim 1, wherein
the at least one drive device is rigidly connected to the chassis.

5. The motor vehicle as claimed in claim 1, wherein
the at least one drive device has an electric motor as a drive machine.

6. The motor vehicle as claimed in claim 5, wherein
at least one electrical power source for supplying power to the at least one drive device is provided which has a housing rigidly connected to the chassis.

7. The motor vehicle as claimed in claim 6, wherein
the at least one electrical power source has a fuel cell, and
a fuel reservoir for the fuel cell is provided which has a housing rigidly connected to the chassis.
